(19) United States
(12) Patent Application Publication
(10) Pub. No.: US 2024/0385620 A1
(43) Pub. Date: Nov. 21, 2024

(54) AUTONOMOUS MOBILE ROBOT FLEET AND CONTROL METHOD THEREOF

(71) Applicant: Wistron Corporation, New Taipei City (TW)

(72) Inventors: Wen-Sen LEE, New Taipei City (TW); Tsun-Hsien KUO, New Taipei City (TW); Chen-Wei YANG, New Taipei City (TW)

(21) Appl. No.: 18/452,747

(22) Filed: Aug. 21, 2023

(30) Foreign Application Priority Data
May 18, 2023 (TW) 112118597

(51) Int. Cl. G05D 1/02; G06Q 50/28

(52) U.S. Cl. CPC G05D 1/0297; G06Q 10/08

(57) ABSTRACT

An autonomous mobile robot fleet includes a service transceiver module, a dispatch module, a robot fleet, a monitoring module, a storage module, and a certificate module. The service transceiver module is configured to receive and send mission information. The dispatch module couples to the service transceiver module, and is configured to generate dispatch information according to the mission information. The robot fleet wirelessly couples to the dispatch module. The robot fleet is used to execute the dispatch information. The monitoring module wirelessly couples to the robot fleet. The monitoring module generates monitoring information according to a status signal from the robot fleet. The storage module couples to the dispatch module and the monitoring module. The certificate module couples to the storage module, and wirelessly couples to the robot fleet. The certificate module is configured to generate certificate information according to the dispatch information and the monitoring information.

### CROSS-REFERENCE TO RELATED APPLICATION

This non-provisional application claims priority under 35 U.S.C. § 119 (a) to patent application No. 112118597 filed in Taiwan, R.O.C. on May 18, 2023, the entire contents of which are hereby incorporated by reference.

### BACKGROUND

### Technical Field

The present disclosure relates to a service management system, and in particular, to an autonomous mobile robot fleet and control method thereof.

### Related Art

Hoteliers set up different forms of service processes according to different service types. Generally speaking, a service process sequentially includes filling-in of a service operation requirement list, preparation of service information goods, preparation of a service device, a service operation process, and acceptance of a service operation.

However, service processes of various departments such as a management department, a room division, and a food and beverage department are independent of each other and not managed in a centralized manner. As a result, a service resource is wasted, and overall service efficiency is affected. In addition, the hoteliers cannot completely master a completion degree and effectiveness of each service mission.

### SUMMARY

In some embodiments, an autonomous mobile robot fleet includes a service transceiver module, a dispatch module, a robot fleet, a monitoring module, a storage module, and a certificate module. The service transceiver module is configured to receive and send mission information. The dispatch module couples to the service transceiver module, and is configured to generate dispatch information according to the mission information. The robot fleet wirelessly couples to the dispatch module, and is used to execute the dispatch information. The monitoring module couples to the robot fleet. The monitoring module is configured to receive at least one status signal from the robot fleet, and generate monitoring information according to the status signal of the robot fleet. The storage module couples to the dispatch module and the monitoring module, and is configured to store the dispatch information and the monitoring information. The certificate module couples to the dispatch module, and wirelessly couples to the robot fleet. The certificate module is configured to generate certificate information according to the dispatch information and the monitoring information.

In some embodiments, the mission information includes project data and location data. The dispatch information includes route data. The dispatch module is further configured to generate the route data according to the project data, the location data, and first map information.

In some embodiments, the robot fleet includes a plurality of robots. The monitoring information includes current status information of the plurality of robots. The current status information of each robot includes idle data. The dispatch module is further configured to transmit the dispatch information to a selected robot in the plurality of robots according to the idle data of each robot.

In some embodiments, the robot fleet includes a plurality of robots. The monitoring information includes current status information of the plurality of robots. The current status information of each robot includes idle data and power data. The dispatch module is further configured to transmit the dispatch information to a selected robot in the plurality of robots according to the project data, the location data, and the idle data and the power data of each robot.

In some embodiments, the robot fleet includes a plurality of robots. The monitoring information includes current status information of the plurality of robots. The current status information of each robot includes idle data, power data, and position data. The dispatch module is further configured to transmit the dispatch information to a selected robot in the plurality of robots, according to the project data, the location data, and the idle data, the power data, and the position data of each robot.

In some embodiments, the robot fleet includes at least one robot. The dispatch information is received and executed by a selected robot in the at least one robot. The selected robot is further configured to send a call signal to the monitoring module during execution of the dispatch information. The monitoring module obtains floor data and plane data according to the call signal, controls a first elevator corresponding to the plane data to a floor corresponding to the floor data, and after the first elevator arrives at the floor, sends back an entry command to the selected robot.

In some embodiments, the robot includes a communication module, a sensing apparatus, a control module, and a moving apparatus. The control module couples to the communication module, the sensing apparatus, and the moving apparatus. The control module, the communication module, and the sensing apparatus are located in the moving apparatus. The control module receives entry information through the communication module, receives, in response to the entry information, an elevator image acquired by the sensing apparatus, analyzes the elevator image to recognize internal space of the first elevator, and drives the moving apparatus according to the internal space.

In some embodiments, the dispatch information includes the project data. The robot includes a communication module, a control module, and a moving apparatus. The control module couples to the communication module and the moving apparatus. The control module and the communication module are located on the moving apparatus. The control module is further configured to generate arrival data after the project data is completed, transmit the arrival data to the monitoring module through the communication module, and drive the moving apparatus to return to a start location.

In some embodiments, the certificate information includes a completion certificate and an exception certificate. When the robot arrives at the start location, the control module is further configured to generate return data and transmit the return data to the certificate module through the communication module. The certificate module confirms, when receiving the return data of any robot, whether there is the dispatch information and the arrival data of the robot, and generates the completion certificate in response to that there is the dispatch information and the arrival data of the same robot, or generates the exception certificate in response to that there is not the arrival data of the same robot.

In some embodiments, the dispatch information includes first map information. The robot includes a communication module, a control module, a storage module, and a moving apparatus. The control module couples to the communication module, the storage module, and the moving apparatus. The control module, the communication module, and the storage module are located on the moving apparatus. The storage module stores second map information. The control module is further configured to download the first map information through the communication module, and update the second map information with the first map information.

In some embodiments, the second map information includes charging location data. The robot further includes a power supply module. The power supply module couples to the control module and located on the moving apparatus. The power supply module stores remaining power, and provides, with the remaining power, power required by operation of the robot. The control module drives the moving apparatus according to the charging location data in response to that the remaining power is less than or equal to a threshold.

In some embodiments, the dispatch information includes cleaning and disinfection data. A robot in the robot fleet includes a cleaning and disinfection apparatus, a communication module, a control module, and a moving apparatus. The control module couples to the communication module, the cleaning and disinfection apparatus, and the moving apparatus. The control module, the communication module, and the cleaning and disinfection apparatus are located on the moving apparatus. The control module receives the dispatch information through the communication module, and controls the cleaning and disinfection apparatus according to the cleaning and disinfection data.

In some embodiments, an autonomous mobile robot fleet control method is provided. At least one piece of monitoring information of at least one robot is stored and mission information is obtained. Dispatch information is generated according to the mission information. The dispatch information is transmitted to a selected robot in the at least one robot according to the monitoring information of each robot. The autonomous mobile robot fleet control method includes: receiving, from the at least one robot, at least one status signal corresponding to the monitoring information of the robot; updating, according to a status signal of each robot, the monitoring information of the robot; and generating certificate information according to the dispatch information and the monitoring information.

In some embodiments, the method further includes: receiving a call signal from the selected robot, the call signal including height data and plane data; controlling an elevator corresponding to the plane data to move to a floor corresponding to the height data; and sending an entry command to the selected robot after the elevator arrives at the floor.

In some embodiments, the method further includes: acquiring an elevator image of the elevator in response to the entry command; analyzing the elevator image to recognize internal space of the elevator; and driving the selected robot according to the internal space.

In some embodiments, a transmission step includes: selecting one of the at least one robot as the selected robot according to idle data in the monitoring information and project data and location data in the dispatch information; and transmitting the dispatch information to the selected robot.

In some embodiments, a transmission step includes: selecting one of the at least one robot as the selected robot according to idle data and power data in the monitoring information and project data and location data in the dispatch information; and transmitting the dispatch information to the selected robot.

In some embodiments, a transmission step includes: selecting one of the at least one robot as the selected robot according to idle data, power data, and position data in the monitoring information and project data and location data in the dispatch information; and transmitting the dispatch information to the selected robot.

In some embodiments, the method further includes: receiving return data from any robot. A generating step is performed in response to the return data. The generating step includes: checking the dispatch information and the monitoring information in response to the return data; and generating a completion certificate when there is the dispatch information of the robot sending the return data and the monitoring information includes arrival data of the robot sending the return data; or generating an exception certificate when there is the dispatch information of the robot sending the return data and the monitoring information does not include the arrival data.

In some embodiments, the method further includes: executing, by the selected robot, the dispatch information; sending back, by the selected robot, the arrival data when completing project data in the dispatch information, and returning to a start location; sending back, by the selected robot, the return data when arriving at the start location; and receiving and recording, in the certificate information, the arrival data from the selected robot.

### BRIEF DESCRIPTION OF THE DRAWINGS

FIG. 1 is a function block diagram of an autonomous mobile robot fleet according to an embodiment.

FIG. 2 is a flowchart of an autonomous mobile robot fleet control method according to an embodiment.

FIG. 3 is a schematic functional block diagram of a robot according to an embodiment.

FIG. 4 is a schematic diagram of a robot according to an embodiment.

FIG. 5 is a schematic function block diagram of a robot according to an embodiment.

FIG. 6 is a schematic diagram of a cleaning and disinfecting robot according to an embodiment.

### DETAILED DESCRIPTION

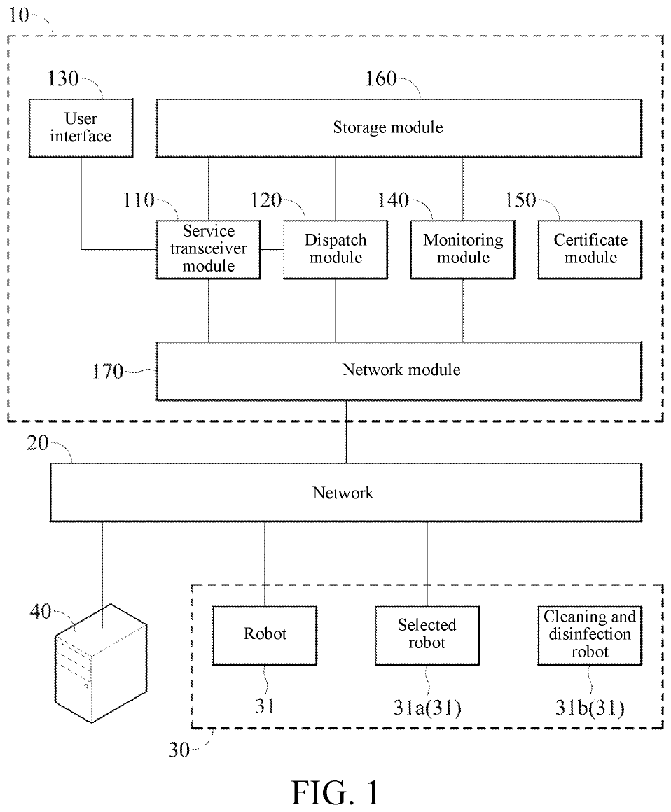

Referring to FIG. 1, an autonomous mobile robot fleet includes a system body 10 and a robot fleet 30. The system body 10 includes a service transceiver module 110, a dispatch module 120, a monitoring module 140, a certificate module 150, and a storage module 160. The autonomous mobile robot fleet is suitable for providing and managing a service. The service that the system is suitable for may be, for example, a hotel service, a catering service, or a guiding service.

The service transceiver module 110 couples to the dispatch module 120. The dispatch module 120, the monitoring module 140, and the certificate module 150 couple to the storage module 160. The dispatch module 120, the monitoring module 140, and the certificate module 150 wirelessly couple to the robot fleet 30.

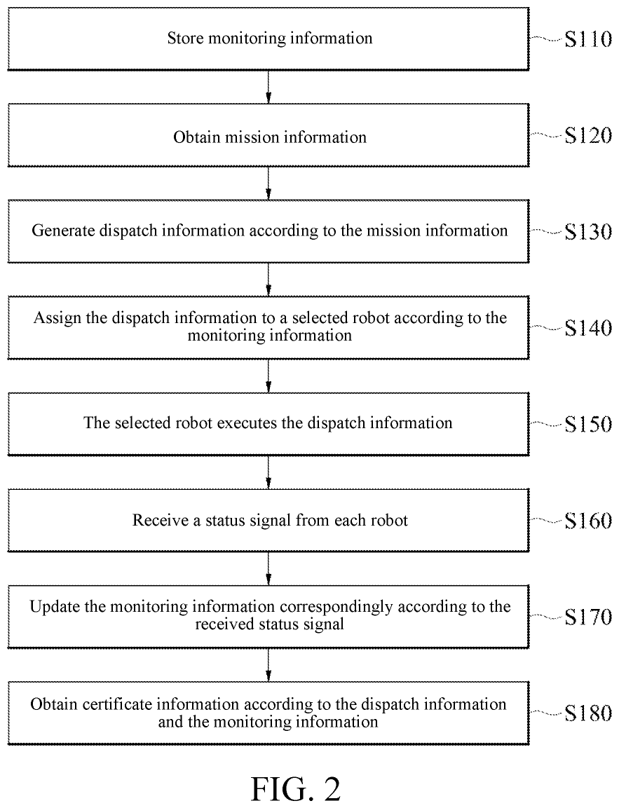

Referring to FIG. 1 and FIG. 2, the robot fleet 30 includes one or more robots 31. The storage module 160 stores monitoring information (step S110). The monitoring information herein records each current status (referred to as a current status hereinafter) of each robot 31. Specifically, the monitoring information includes current status information of each robot 31.

The service transceiver module 110 is configured to receive and send mission information (step S120). The mission information corresponds to a service requirement. In other words, one piece of mission information may represent one work mission, and the work mission may be performed to meet a corresponding service requirement. Therefore, the mission information includes project data for indicating mission content of the work mission, time data for indicating time at which the work mission is required to be performed, and location data for indicating a location at which the work mission is performed. In some embodiments, a hotel service is used as an example. If the mission information represents a work mission for meeting a service requirement that Room 301 needs cleaning and mineral water at 8 am, the project data in the mission information is “clean the room and provide mineral water”, the time data of performing the mission in the mission information is “8 am”, and the location data of performing the mission in the mission information is “Room 301”. In addition, the mission information may alternatively represent a work mission of delivering a room supply, a work mission of disinfecting a gymnasium in a hotel, or a work mission of welcoming guests in a hotel lobby.

The dispatch module 120 is configured to generate dispatch information according to the mission information (step S130). Each piece of dispatch information includes corresponding mission information, identification data for indicating a robot 31 that performs a corresponding mission, and route data for indicating a moving path when the mission is performed. In other words, each piece of dispatch information includes project data, location data, time data, identification data, and route data. In some embodiments, the dispatch module 120 may further store the generated dispatch information in the storage module 160.

Referring to FIG. 1 and FIG. 2, in addition, the dispatch module 120 may also assign (transmit) the dispatch information to a specific robot 31 (referred to as a selected robot 31a hereinafter) in the robot fleet 30 according to the monitoring information (step S140, that is, a transmission step), so that the selected robot 31a executes the dispatch information to meet the service requirement corresponding to the mission (step S150). In some embodiments, the system body 10 of the autonomous mobile robot fleet may further include a network module 170. The dispatch module 120 couples to the network module 170. The dispatch module 120 communicates with any robot 31 in the robot fleet 30 through the network module 170, so that the dispatch module 120 may transmit, through a network 20, the dispatch information to the selected robot 31a that the dispatch information is assigned to.

Referring to FIG. 1 and FIG. 2, the monitoring module 140 may receive a status signal from each robot 31 (step S160), and then correspondingly update the monitoring information according to the received status signal (step S170). The status signal may be a current status signal. Specifically, the monitoring module 140 may receive current status signals of all the robots 31 in the robot fleet 30 according to a fixed period or a variable period, then correspondingly form current status information of each robot 31 according to the received current status signals, and correspondingly update the current status information of the robot 31 in the monitoring information with the formed current status information of each robot 31. In other words, the monitoring module 140 may monitor current statuses of all the robots 31 and update the monitoring information at any time. In some embodiments, the system body 10 of the autonomous mobile robot fleet may further include a network module 170. The monitoring module 140 couples to the network module 170. The monitoring module 140 communicates with any robot 31 in the robot fleet 30 through the network module 170, so that the monitoring module 140 may receive the status signal from each robot 31 through a network 20.

Referring to FIG. 1 and FIG. 2, the certificate module 150 may generate certificate information according to the dispatch information and the monitoring information (step S180). In some embodiments, when the selected robot 31a executes the dispatch information, the selected robot 31a may report a working status to the autonomous mobile robot fleet. Specifically, the selected robot 31a sends a working status signal to the monitoring module 140 through the network 20. In this case, the monitoring module 140 may correspondingly form working status information of this robot 31 according to the received working status signal, and store the formed working status information in the storage module 160. In other words, the status signal may also be the working status signal. The monitoring information further includes working status information of each robot 31. Then, the monitoring module 140 may monitor the working status of the selected robot 31a and update the monitoring information at any time. After the selected robot 31a completes the dispatch information, the certificate module 150 may determine, by confirming the monitoring information in the storage module 160, whether the generated certificate information is a completion certificate or an exception certificate.

Referring to FIG. 1, in some embodiments, the service transceiver module 110 may couple to an execution management system 40 of each execution unit in a wired or wireless manner, and receive the mission information from the execution management system 40 (an example of step S120). In other words, the system body 10 of the autonomous mobile robot fleet may further include a network module 170. The service transceiver module 110 couples to the network module 170. The autonomous mobile robot fleet communicates with the execution management system 40 of each execution unit through the network module 170, so that the service transceiver module 110 may receive the mission information from the execution management system 40 through the network 20. In some embodiments, the execution management system 40 of each execution unit may receive data (for example, a mission project, mission time, a mission location, or a combination thereof) of a service requirement of a service user and generate the mission information through a user interface 130 (for example, a keyboard and a mouse, or a touch screen). Then, the execution management system 40 transmits the mission information to the autonomous mobile robot fleet through the network 20, so that the robot 31 meets the service requirement of the service user according to the mission information. In some embodiments, a hotel service is used as an example, and the execution unit may be, for example, a counter, a management department, a food and beverage department, or a room division.

Referring to FIG. 1, in some embodiments, the system body 10 of the autonomous mobile robot fleet may further include a user interface 130. The service transceiver module 110 couples to the user interface 130. The user interface 130 herein may be provided for a user to enter a service requirement of the service user. In other words, the service transceiver module 110 may receive various data of the service requirement of the service user through the user interface 130, and form the mission information according to the data (another example of step S120).

In some embodiments, a format of the mission information may be a structured data format, an unstructured data format, or a combination thereof. The structured data format includes data structured by using an application information system, for example, relational database data.

Referring to FIG. 1, in some embodiments, the service transceiver module 110 further couples to the storage module 160. The service transceiver module 110 may store the obtained mission information in the storage module 160, and instantly update the mission information added by each execution management system 40 to the autonomous mobile robot fleet for future access and check. In some embodiments, mission information of the unstructured data format may be, for example, sequential alphanumeric data of a JavaScript Object Notation (JSON) data exchange format.

Referring to FIG. 1, in some embodiments, the dispatch information transmitted by the dispatch module 120 to the robot 31 may be encrypted by using an asymmetric cryptographic algorithm. In other words, in addition to the dispatch information, a signal received by the robot 31 from the dispatch module 120 also carries a hash value (referred to as a first hash value hereinafter) obtained by operating the dispatch information by using the asymmetric cryptographic algorithm. Therefore, after receiving the wireless signal, the robot 31 may first operate the dispatch information by using the same asymmetric cryptographic algorithm to obtain another hash value (referred to as a second hash value hereinafter), and confirm whether the second hash value is the same as the first hash value, to determine whether the received dispatch information is available. If the encrypted hash value is the same as the original hash value, the robot 31 determines that the dispatch information is not tampered. The asymmetric cryptographic algorithm may be, for example, RSA, ElGmal, an elliptic curve cryptosystem (ECC), or Diffie-Hellman key exchange.

Referring to FIG. 1 and FIG. 2, in some embodiments, the current status of the robot 31 may include an intrinsic state and a moving state. The intrinsic state may be, for example, remaining power (that is, current remaining power of the robot 31), a service life of each lamp, a movement speed, whether there is storage space, or any combination thereof. The moving state may be, for example, a current position, a floor in which the robot is located, whether the robot takes an elevator, or any combination thereof. Specifically, the current status information of each robot 31 includes idle data for indicating whether the robot 31 is currently working or idle, power data for indicating remaining power of the robot 31, and position data for indicating the current position of the robot 31. In some embodiments, the current status signal carries one or more pieces of data, for example, the idle data, the power data, the position data, or any combination thereof. Therefore, when the monitoring module 140 receives the current status signal from any robot 31 (an example of step S160), the monitoring module 140 reads one or more pieces of data carried in the current status signal, and correspondingly updates the same data of the robot 31 stored in the storage module 160 (an example of step S160).

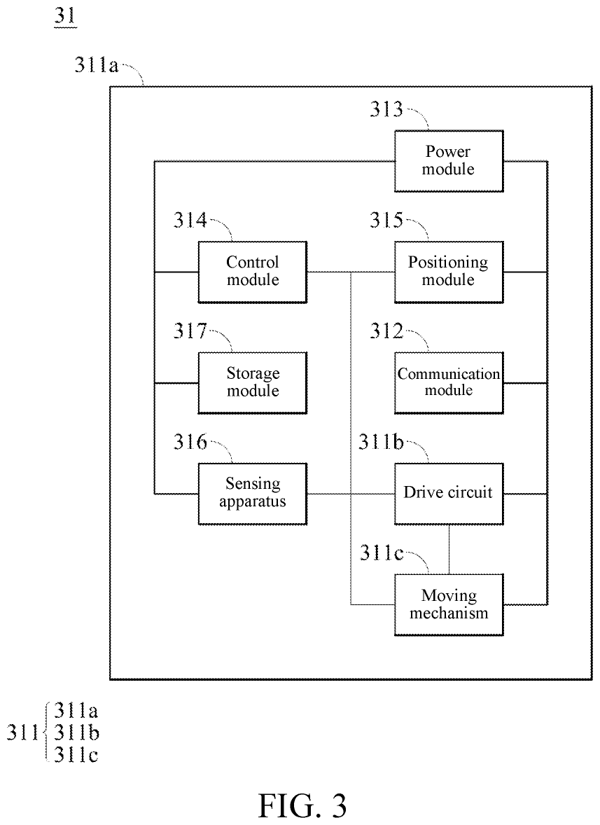

Referring to FIG. 1 and FIG. 3, in some embodiments, the robot 31 may include a moving apparatus 311, a communication module 312, a power module 313, and a control module 314. The control module 314 couples to a drive circuit 311b of the moving apparatus 311, the communication module 312, and the power module 313. The communication module 312, the power module 313, and the control module 314 are located in a housing 311a of the moving apparatus 311. The control module 314 is configured to control the moving apparatus 311, the communication module 312, and the power module 313. The power module 313 stores power, and is configured to provide, with the power, power required by operation of the robot 31, that is, supply power to each assembly (for example, the moving apparatus 311, the communication module 312, and the control module 314), required to be enabled with power, of the robot 31. The control module 314 may wirelessly couple to the monitoring module 140 and the dispatch module 120 through the communication module 312, thereby through the network 20, receiving the dispatch information sent by the dispatch module 120 and sending the status signal (that is, the current status signal and/or the working status signal) to the monitoring module 140. That is, the robot 31 communicates with the system body 10. The moving apparatus 311 enables the robot 31 to move at a travel speed. Specifically, when the control module 314 executes the dispatch information, the control module 314 enables the drive circuit 311b of the moving apparatus 311 to drive a moving mechanism 311c of the moving apparatus 311. Then, the moving mechanism 311c may move relative to the ground, so that the robot 31 moves on the ground. In addition, the control module 314 may also control the moving mechanism 311c of the moving apparatus 311 according to the dispatch information, so that the robot 31 moves along a route indicated by the route data.

Referring to FIG. 1 and FIG. 3, in some embodiments, the robot 31 may further include a positioning module 315. The positioning module 315 is located in the moving apparatus 311, and couples to the control module 314. The positioning module 315 generates the position data according to a position of the robot 31. For example, the position data may include plane data (for example, a longitude and a latitude) representing a plane position of the robot 31 and height data (for example, a floor or an altitude) representing a relative vertical height at which the robot 31 is located. The height data corresponds to floor data.

Referring to FIG. 1 and FIG. 3, in some embodiments, when the robot 31 is intended to send the current status signal, the control module 314 obtains the position data from the positioning module 315, obtains the power data from the power module 313, generates the current status signal according to the obtained position data and power data, and sends the current status signal to the monitoring module 140 through the communication module 312.

Referring to FIG. 1 and FIG. 2, in some embodiments, the storage module 160 may further store map information (referred to as first map information hereinafter). In an example of step S130, the dispatch module 120 may generate route data according to the project data and the location data in the mission information, position data of each robot 31 in the monitoring information, and the first map information. Specifically, the dispatch module 120 may obtain the location data and the project data from the mission information, obtain the position data from the current status information of the selected robot 31a in the monitoring information, and obtain, through an operation according to the project data, a route from a location represented by the position data to a location represented by the location data and a route from the location represented by the location data to a start location in the first map information, that is, obtain the route data. The start location may be the location represented by the position data, or another specified location. In some embodiments, a hotel service is used as an example. The map information includes a plan view of all floors of a hotel. The route data is a travel route from a position (that is, the position data) of the robot 31 to a location (that is, the location data) at which the work mission is performed. In some embodiments, the dispatch module 120 confirms, according to the project data, whether there is a halfway position. The halfway position is a location that the robot needs to first pass through before arriving at the position represented by the location data, for example, a supply location at which a supply is obtained, a location at which the height data is changed, or a tool storage location at which a cleaning tool is obtained. If there is a halfway position, the dispatch module 120 obtains, through an operation, a route that is from the location represented by the position data to the location represented by the location data and that passes through the halfway position and the route from the location represented by the location data to the start location in the first map information, that is, obtains the route data. If there is no halfway position, the dispatch module 120 obtains, through an operation, the route from the location represented by the position data to the location represented by the location data and the route from the location represented by the location data to the start location in the first map information, that is, obtains the route data.

Referring to FIG. 1 and FIG. 3, in addition, when the selected robot 31a executes the dispatch information, the control module 314 continuously obtains the position data from the positioning module 315, and controls, according to the obtained position data and the route data in the dispatch information, the moving mechanism 311c to adjust a direction, so that the selected robot 31a goes ahead along the route indicated by the route data. For example, when the project data represents delivery of a room supply, the route data represents a route from the position (that is, the position data) of the selected robot 31a to a supply location at which the selected robot 31a may obtain the supply, and a route that the selected robot 31a moves from the supply location to a location (that is, the location data) at which the work mission is performed. In some embodiments, the positioning module 315 may be implemented by a global positioning system (GPS) or an inertial sensor. In some embodiments, the positioning module 315 may also calculate, by using an algorithm, the position data according to a wireless signal (for example, a wireless fidelity (Wi-Fi) signal, a Bluetooth signal, or an ultra-wideband (UWB) signal) obtained by the communication module 312 or an image acquired by a sensing module. An algorithm suitable for calculating the position data is well known to a person skilled in the art, and thus will not be elaborated herein.

Referring to FIG. 1 and FIG. 3, in some embodiments, every time when the selected robot 31a starts to execute the dispatch information, the control module 314 of the selected robot 31a may generate idle data representing that the selected robot 31a is working, and send a current status signal including the idle data to the monitoring module 140 through the communication module 312, so that the monitoring module 140 updates the idle data of the current status information (that is, the monitoring information) of the selected robot 31a in the storage module 160. In addition, when the selected robot 31a enters an idle state (for example, the selected robot 31a completes the work mission or returns to the start location), the selected robot 31a may generate idle data representing that the selected robot 31a is idle, and send the current status signal including the idle data to the monitoring module 140 through the communication module 312, so that the monitoring module 140 updates the idle data (that is, the monitoring information) of the current status information of the selected robot 31a in the storage module 160. Therefore, the autonomous mobile robot fleet may know, according to the idle data of each robot 31 in the monitoring information, whether each robot 31 is currently in the idle state or in a state of performing the dispatch information (that is, working).

Referring to FIG. 1 and FIG. 2, in an example of step S140, the dispatch module 120 may select a robot 31 in the idle state from the robot fleet 30 as the selected robot 31a according to the idle data of each robot 31 in the monitoring information, and transmit the dispatch information to the selected robot 31a through the network module 170. Based on this, a case that a robot 31 receiving the dispatch information is performing another piece of dispatch information and cannot immediately perform the received dispatch information may be avoided, thereby improving overall working efficiency of the robot fleet 30.

Referring to FIG. 1 and FIG. 2, in another example of step S140, the dispatch module 120 may also select a proper robot 31 from the robot fleet 30 as the selected robot 31a according to the mission information and the idle data and the power data of each robot 31 in the monitoring information, and transmit the dispatch information to the selected robot 31a. Specifically, the dispatch module 120 may estimate power (referred to as estimated power hereinafter) of the robot 31 required to be spent on executing the dispatch information according to the project data in the mission information and the route data, then select a robot 31 that is in the idle state and that has remaining power more than or equal to the estimated power from the robot fleet 30 as the selected robot 31a according to the estimated power and the power data and the idle data of each robot 31 in the monitoring information, and transmit the dispatch information to the selected robot 31 through the network module 170. The route data may be a route from the start location to the location at which the work mission is performed. The start location may be a position of the robot 31 in the idle state in the robot fleet 30. Therefore, a case that the selected robot 31 is in low battery and cannot effectively complete the mission may be avoided. For example, a case that during execution of the dispatch information, the robot 31 runs out of power and stops halfway or goes to a charging location instead for charging and thus the mission is delayed can be avoided. Specifically, during selection of the proper robot 31, the dispatch module 120 selects a robot 31 in high battery from a plurality of robots in the idle state as the selected robot 31a according to a plurality of pieces of idle data and a plurality of pieces of power data, and transmits the dispatch information to the selected robot 31a. In some embodiments, the dispatch module 120 determines estimated power according to the dispatch information, and then selects, based on the estimated power and power data of all the robots 31, a matched robot 31 from one or more robots 31 whose idle data indicates the idle state as the selected robot 31a.

Referring to FIG. 1 and FIG. 2, in still another example of step S140, the dispatch module 120 may also select a proper robot 31 as the selected robot 31a according to the mission information and the idle data, the power data, and the position data of each robot 31 in the monitoring information, and transmit the dispatch information to the selected robot 31a. In this case, the dispatch module 120 determines, according to the location data and the project data in the mission information and the position data of each robot 31, a length of a moving path of each robot 31 for execution of the dispatch information. Therefore, in addition to determining, according to the idle state and the power status of each robot 31, the robot 31 to be selected, the dispatch module 120 may alternatively determine, according to the length of the moving path of each robot 31 for execution of the dispatch information, the robot 31 to be selected. In this way, overall working efficiency of the robot fleet 30 is improved. Specifically, the dispatch module 120 selects the robot 31 in the idle state from the robot fleet 30 according to the idle data and the power data of each robot 31. Then, the dispatch module 120 calculates, according to the position data of each robot 31 in the idle state and the location data and the project data in the mission information, the moving path (referred to as a mission path hereinafter, that is, a shortest route from the location represented by the position data to the location represented by the location data, where whether the shortest path passes through a halfway position is determined by the project data) for execution of the dispatch information and estimated power required by the robot 31 to move along the corresponding mission path. Then, the dispatch module 120 selects a robot 31 corresponding to a shortest mission path from the robot 31 that is in the idle state and that has remaining power matching the estimated power as the selected robot 31a, that is, transmits the dispatch information to the robot 31 that is in the idle state, that has sufficient remaining power, and that corresponds to the shortest mission path.

Referring to FIG. 1, in some embodiments, the monitoring module 140 may further be configured to monitor an electronic apparatus outside the autonomous mobile robot fleet, for example, an elevator, an electric door, an escalator, or any combination thereof. The position data includes height data (referred to as first height data hereinafter) and plane data (referred to as first plane data hereinafter). The location data includes another piece of height data (referred to as second height data hereinafter) and another piece of plane data (referred to as second plane data hereinafter). It is assumed that the first height data is inconsistent with the second height data. For example, a floor represented by the first height data is different from that represented by the second height data. The route data in the dispatch information includes a halfway position. The following uses an example in which the halfway position is at a door of a first elevator.

Referring to FIG. 1, during execution of the dispatch information, the selected robot 31a may generate a call signal at the door of the first elevator, and transmit the call signal to the monitoring module 140. The call signal includes the position data representing the position of the selected robot 31a. In addition, the position data includes height data (referred to as third height data hereinafter) representing a floor in which the selected robot 31a is located and plane data (referred to as third plane data hereinafter) representing a plane position (that is, the halfway position) of the selected robot 31a. The monitoring module 140 obtains the floor and the plane position of the selected robot 31a according to the call signal and the floor data. Specifically, the monitoring module 140 may obtain the third height data and the third plane data from the call signal, control the first elevator corresponding to the third plane data to a floor corresponding to the third height data, and after the first elevator arrives at the floor corresponding to the third height data, send back an entry command to the selected robot 31a. The selected robot 31a executes the entry command to enter the first elevator. When the first elevator moves to a floor represented by the second height data, the first elevator may send an arrival signal to the monitoring module 140. After receiving the arrival signal, the monitoring module 140 may send a movement command to the selected robot 31a, so that in response to the movement command, the moving apparatus 311 of the selected robot 31a leaves the first elevator, and continues to move along the route indicated by the route data. Therefore, when the robot 31 needs to go to floors corresponding to different height data for a work mission, the selected robot 31a may change a height at which the selected robot 31a is located, to effectively complete the work mission.

Referring to FIG. 1 to FIG. 4, in some embodiments, one or more robots 31 in the robot fleet 30 may include a sensing apparatus 316. For dispatch information in which the first height data is inconsistent with the second height data, the dispatch module 120 may select the robot 31 with the sensing apparatus 316 as the selected robot 31a. In other words, the robot 31 may further include the sensing apparatus 316. The sensing apparatus 316 is located in the moving apparatus 311, and a lens thereof is embedded to the housing 311a of the moving apparatus 311. The sensing apparatus 316 couples to the control module 314 and is powered by the power module 313. The control module 314 receives the entry command through the communication module 312, receives, in response to the entry command, an elevator image acquired by the sensing apparatus 316, analyzes the elevator image to recognize internal space of the first elevator, and when the recognized internal space allows the selected robot 31a to enter, drives the moving apparatus 311, so that the selected robot 31a enters the first elevator from the door of the first elevator. Specifically, before the selected robot 31a enters the first elevator, the control module 314 may determine, by first using the elevator image acquired by the sensing apparatus 316, whether remaining space in the first elevator allows the selected robot 31a to enter. Once the control module 314 determines that the remaining space allows the selected robot 31a to enter, the control module 314 may control the moving apparatus 311 to move forward, so that the selected robot 31a enters the first elevator to take the first elevator.

Referring to FIG. 1 to FIG. 4, in some embodiments, when the control module 314 determines that the remaining space does not allow the selected robot 31a to enter, the control module 314 may control the moving apparatus 311 to stand still, so that the selected robot 31a stands still and does not enter the first elevator. Then, the control module 314 may send another call signal (referred to a recall signal hereinafter) to the monitoring module 140 and the dispatch module 120. The monitoring module 140 controls, according to the recall signal, another elevator (referred to as a second elevator hereinafter) corresponding to the third plane data to move to a floor corresponding to the third height data. The dispatch module 120 generates and sends back a transfer route data to the control module 314 according to the recall signal, the third plane data, and the plane position of the second elevator. The control module 314 receives the transfer route data through the communication module 312, and controls, according to the transfer route data, the moving apparatus 311 to move to the position of the second elevator. At a door of the second elevator, the selected robot 31a determines whether to enter the second elevator in a same manner in which whether to enter the first elevator is determined. In some embodiments, during execution of the dispatch information, the control module 314 may determine, according to a number of sending times of the call signal, whether to continue to execute the dispatch information (that is, resend the call signal) in a case that another elevator cannot be entered.

Referring to FIG. 1 to FIG. 4, in some embodiments, when the control module 314 determines that the remaining space does not allow the selected robot 31a to enter, the control module 314 may determine not to continue to execute the dispatch information, and control the moving apparatus 311 to move, so that the selected robot 31a returns to the start location.

In some embodiments, the call signal may further include event data. The event data represents an event of an external electronic apparatus to be called, for example, calling an elevator.

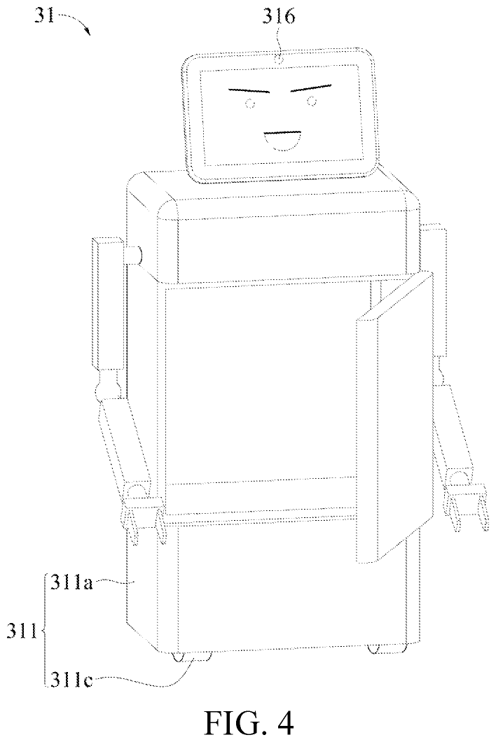

Referring to FIG. 1 and FIG. 4, in some embodiments, the dispatch information includes the project data. The control module 314 is further configured to generate arrival data after the project data is completed, and drive the moving apparatus 311 to move to the start location. In this case, the control module 314 may transmit a working status signal carrying the arrival data to the monitoring module 140 through the communication module 312. Then, the monitoring module 140 records the arrival data and the working status information of the selected robot 31a in the monitoring information. In some embodiments, the start location may be a set position preset for the robot fleet 30, a position at which the selected robot 31a starts to execute the dispatch information, a position of the robot 31 in the idle state, or a charging position at which the robot 31 is charged. The selected robot 31a may move to the start location after the dispatch information is executed or when the dispatch information cannot be executed. In addition, when the selected robot 31a arrives at the start location, the control module 314 may generate return data, and transmit the return data to the certificate module 150 through the communication module 312.

Referring to FIG. 1, FIG. 2, and FIG. 3, in some embodiments, the certificate information includes a completion certificate and an exception certificate. When receiving return data of any robot 31, the certificate module 150 confirms whether there is the dispatch information and the arrival data of the robot 31 (that is, whether the dispatch information and the arrival data of the robot 31 are stored in the storage module 160), and generates the completion certificate in response to that there is the dispatch information and the arrival data of the same robot 31 (that is, the robot 31 sending the return data), or generates the exception certificate in response to that there is not the arrival data of the same robot 31. The exception certificate represents that the robot 31 has an exception and cannot smoothly complete the dispatch information during execution of the dispatch information. In addition, the exception certificate records various reasons why the mission cannot be completed, so that related personnel may adjust a related working process according to the exception certificate.

Referring to FIG. 1 to FIG. 4, in some embodiments, each robot 31 may further include a storage module 317. The storage module 317 is located in the housing 311a of the moving apparatus 311, and couples to the control module 314. The storage module 317 stores map information (referred to as second map information hereinafter). The control module 314 further downloads the first map information from the system body 10 through the communication module 312, and updates the second map information with the first map information. Specifically, the dispatch module 120 may transmit the first map information while a first map is updated or the dispatch information is transmitted. When receiving the first map information, the control module 314 of the selected robot 31a may determine whether there is a difference between the first map information and the second map information. When the control module 314 determines that there is a difference, it indicates that the second map information needs to be updated. In this case, the control module 314 updates the second map information with the first map information downloaded from the dispatch module 120. When there is no difference, the control module 314 directly discards the received first map information.

Referring to FIG. 1 and FIG. 3, in some embodiments, the first map information transmitted by the dispatch module 120 to the robot 31 may be encrypted by using an asymmetric cryptographic algorithm. In other words, in addition to the first map information, the signal received by the control module 314 from the dispatch module 120 carries a hash value (referred to as a third hash value hereinafter) obtained by operating the first map information by using the asymmetric cryptographic algorithm. Before updating the second map information, the control module 314 may first determine, according to the third hash value, whether the first map information is from a valid source, that is, whether the first hash value is correct, thereby avoiding update with wrong map information. Specifically, the control module 314 first operates the received first map information by using the same asymmetric cryptographic algorithm to obtain another hash value (referred to as a fourth hash value hereinafter), and confirms whether the third hash value is the same as the fourth hash value, to determine whether the received first map information is available. If the third hash value is the same as the fourth hash value, the first map information is available, that is, is from a valid source. If the third hash value is different from the fourth hash value, the first map information is unavailable, that is, is from an invalid source.

Referring to FIG. 1 to FIG. 4, in some embodiments, the second map information includes charging location data representing a charging location. In this case, the control module 314 drives, according to the charging location data in response to that the remaining power is less than or equal to a threshold, the moving apparatus 311 to move to the charging location, so that the robot 31 moves to the charging location for charging.

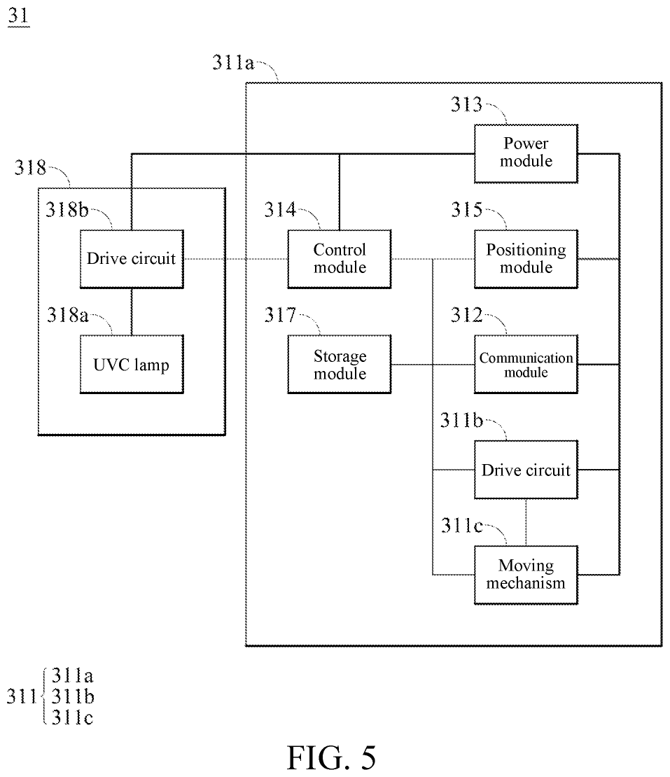

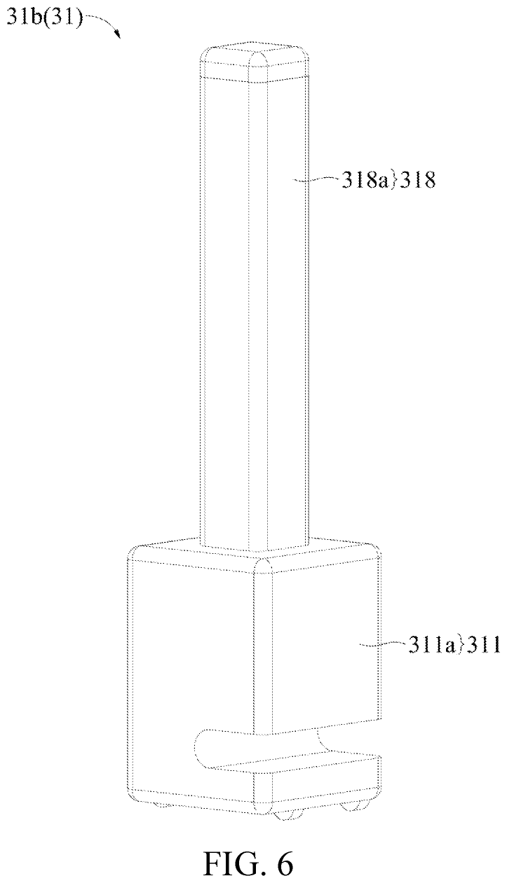

Referring to FIG. 1, FIG. 2, FIG. 5, and FIG. 6, in some embodiments, the project data in the dispatch information may be cleaning and disinfection data. One or more robots 31 in the robot fleet 30 may include a cleaning and disinfection apparatus 318. Specifically, the robot 31 with the cleaning and disinfection apparatus 318 is a cleaning and disinfection robot 31b. For dispatch information with cleaning and disinfection data, the dispatch module 120 may select a cleaning and disinfection robot 31b in the idle state from the robot fleet 30 as the selected robot 31a. Therefore, when receiving the dispatch information through the communication module 312, the control module 314 may control the cleaning and disinfection apparatus 318 for cleaning and disinfection according to the cleaning and disinfection data in the dispatch information.

In some embodiments, the cleaning and disinfection apparatus 318 is (for example, but not limited to) a disinfectant spraying apparatus or an ultraviolet apparatus. The disinfectant spraying apparatus sprays disinfectant liquid (for example, alcohol) in a mist manner.

Referring to FIG. 5, in some embodiments, the cleaning and disinfection apparatus 318 may include a plurality of ultraviolet C (UVC) lamps 318a and a drive circuit 318b. The plurality of UVC lamps 318a is located on the moving apparatus 311. Each UVC lamp 318a is configured to emit ultraviolet light. The drive circuit 318b couples to the plurality of UVC lamps 318a and is located on the moving apparatus 311. The drive circuit 318b is configured to drive the plurality of UVC lamps 318a. The control module 314 couples to the moving apparatus 311, the communication module 312, and the drive circuit 318b. The control module 314 is located on the moving apparatus 311, and is configured to receive the dispatch information through the communication module 312. The control module 314 enables the moving apparatus 311 and the drive circuit 318b according to the dispatch information.

Referring to FIG. 1 to FIG. 4, for example, a hotel service is used as an example. It is assumed that the position of the robot 31 in the idle state is in the first floor of a hotel, a supply is in a basement of the hotel, and the mission information is providing mineral water for Room 601. After receiving the mission information (step S120), the service transceiver module 110 transmits the mission information to the dispatch module 120. The dispatch module 120 generates the dispatch information according to the mission information (step S130). The dispatch module 120 obtains the monitoring information from the monitoring module 140 (step S110). The dispatch module 120 selects a proper robot 31 as the selected robot 31a from the robot fleet 30 according to information (for example, the idle data, the power data, and the position data) in the monitoring information, and transmits the dispatch information to the selected robot 31a (step S140). The selected robot 31a executes the dispatch information, and moves to the location represented by the position data to perform the work mission. During execution of the dispatch information, if the selected robot 31a needs to move to different floors to execute the dispatch information, the selected robot 31a first moves to the first elevator, and then sends the call signal to the monitoring module 140. After receiving the call signal, the monitoring module 140 controls the first elevator to move to the floor in which the selected robot 31a is located. After the first elevator moves to the floor in which the robot 31 is located, the first elevator sends the arrival signal to the monitoring module 140. After receiving the arrival signal, the monitoring module 140 sends the entry command to the selected robot 31a, to instruct the selected robot 31a to enter the first elevator. When the first elevator arrives at the floor represented by the location data, the first elevator may send the arrival data to the monitoring module 140. After receiving the arrival data, the monitoring module 140 sends the movement command to the selected robot 31a, so that in response to the movement command, the moving apparatus 311 of the selected robot 31a leaves the first elevator, and continues to move along the route data. Before the selected robot 31a enters the first elevator, the sensing apparatus 316 obtains the elevator image of the first elevator. When the control module 314 determines, according to the elevator image, that space in the first elevator allows the selected robot 31a to enter, the control module 314 drives the moving apparatus 311 to move, so that the selected robot 31a enters the first elevator from the door of the first elevator. When the control module 314 determines, according to the elevator image, that space in the first elevator does not allow the selected robot 31a to enter, the control module 314 may control the moving apparatus 311 to stand still, so that the selected robot 31a stands still and does not enter the first elevator. The control module 314 sends recall information to the monitoring module 140 and the dispatch module 120. After receiving the recall information, the monitoring module 140 controls the second elevator to move to the floor in which the selected robot 31a is located. The dispatch module 120 generates and sends back the transfer route data to the control module 314 according to the recall signal, the third plane data, and the plane position of the second elevator. The control module 314 receives the transfer route data through the communication module 312, and controls, according to the transfer route data, the moving apparatus 311 to move to the position of the second elevator. After completing the project data, the selected robot 31a generates the arrival data, and drives the moving apparatus 311 to move to the start location. In this case, the control module 314 transmits the working status signal carrying the arrival data to the monitoring module 140 through the communication module 312. When the selected robot 31a arrives at the start location, the control module 314 generates the return data, and transmits the return data to the certificate module 150 through the communication module 312. When the certificate module 150 receives the return data, if there is the dispatch information and the arrival data, the certificate module 150 generates the completion certificate. If there is not the arrival data, the certificate module 150 generates the exception certificate (step S180). When the control module 314 executes the dispatch information, the control module 314 obtains the position data from the positioning module 315, obtains the power data from the power module 313, generates the current status signal according to the obtained position data and power data, and sends the current status signal to the monitoring module 140 through the communication module 312, so that the monitoring module 140 obtains the current status signal of the selected robot 31a (step S160). Then, the monitoring module 140 updates the monitoring information according to the received current status signal (step S170). In this way, entire autonomous mobile robot fleet is completed.

Referring to FIG. 1, in some embodiments, the system body 10 may be one or more computer hosts or one or more servers. The service transceiver module 110, the dispatch module 120, the user interface 130, and the certificate module 150 may be implemented by one or more processors.

In some embodiments, the storage module 160 and the storage module 317 each may be implemented by one or more memories, one or more hard disk drives, or one or more solid-state drives.

In some embodiments, the network module 170 may be implemented by a communication chip, a transceiver, or a circuit that supports a wireless local area network (WLAN), wireless broadband (WiBro), worldwide interoperability for microwave access (WiMAX), high speed downlink packet access (HSDPA), or another type of wireless wide area network (WWAN) communication technologies.

In some embodiments, the moving mechanism 311c of the moving apparatus 311 has a motor and a wheel set or a belt set coupling to the motor. The drive circuit 311b of the moving apparatus 311 applies a voltage to the motor, and then the motor rotates the wheel set or the belt set, thereby driving the robot 31 to move.

In some embodiments, the control module 314 may be implemented by one or more processors.

In some embodiments, the power module 313 includes a storage battery and a charge and discharge circuit coupling to the storage battery.

In some embodiments, the communication module 312 may be implemented by a communication chip, a transceiver, a circuit, a 4th-generation (4G) network, or a 5th-generation (5G) network that supports the WLAN, WiBro, WiMAX, HSDPA, or another type of WWAN communication technologies.

In some embodiments, the sensing apparatus 316 may be implemented by an optical radar (LIDAR), ultrasonic, a camera, or a video camera.

In summary, according to the autonomous mobile robot fleet and the method thereof in any embodiment, mission information may be effectively integrated, monitoring information of a service process may be connected, a completion degree of the mission information may be effectively mastered, and overall efficiency may be improved. In some embodiments, according to the autonomous mobile robot fleet and the method thereof, a proper robot may be selected according to an idle state, power of the robot, and a length of a moving path to execute the dispatch information, the robot can move to different floors to execute the dispatch information, the robot may be controlled to be cleaned and disinfected, or any combination of the foregoing may be implemented.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. An autonomous mobile robot fleet, comprising:
a service transceiver module, configured to receive and send mission information;
a dispatch module, coupling to the service transceiver module and configured to generate dispatch information according to the mission information;
a robot fleet, wirelessly coupling to the dispatch module and configured to execute the dispatch information;
a monitoring module, wirelessly coupling to the robot fleet and configured to receive at least one status signal from the robot fleet and form monitoring information according to the at least one status signal;
a storage module, coupling to the dispatch module and the monitoring module and configured to store the dispatch information and the monitoring information; and
a certificate module, coupling to the storage module, wirelessly coupling to the robot fleet, and configured to generate certificate information according to the dispatch information and the monitoring information.

2. The autonomous mobile robot fleet according to claim 1, wherein the mission information comprises project data and location data, and the dispatch information comprises route data; and the dispatch module is further configured to generate the route data according to the project data, the location data, and first map information.

3. The autonomous mobile robot fleet according to claim 2, wherein the robot fleet comprises a plurality of robots, the monitoring information comprises current status information of the plurality of robots, and the current status information of each robot comprises idle data; and the dispatch module is further configured to transmit the dispatch information to a selected robot in the plurality of robots according to the idle data of each robot.

4. The autonomous mobile robot fleet according to claim 2, wherein the robot fleet comprises a plurality of robots, the monitoring information comprises current status information of the plurality of robots, and the current status information of each robot comprises idle data and power data; and the dispatch module is further configured to transmit the dispatch information to a selected robot in the plurality of robots according to the project data, the location data, and the idle data and the power data of each robot.

5. The autonomous mobile robot fleet according to claim 2, wherein the robot fleet comprises a plurality of robots, the monitoring information comprises current status information of the a plurality of robots, and the current status information of each robot comprises idle data, power data, and position data; and the dispatch module is further configured to transmit the dispatch information to a selected robot in the plurality of robots, according to the project data, the location data, and the idle data, the power data, and the position data of each robot.

6. The autonomous mobile robot fleet according to claim 1, wherein the robot fleet comprises at least one robot, and the dispatch information is received and executed by a selected robot in the at least one robot; the selected robot is further configured to send a call signal to the monitoring module during execution of the dispatch information; and the monitoring module obtains floor data and plane data according to the call signal, controls a first elevator corresponding to the plane data to a floor corresponding to the floor data, and after the first elevator arrives at the floor, sends back an entry command to the selected robot.

7. The autonomous mobile robot fleet according to claim 6, wherein the robot comprises a communication module, a sensing apparatus, a control module, and a moving apparatus; the control module couples to the communication module, the sensing apparatus, and the moving apparatus; the control module, the communication module, and the sensing apparatus are located in the moving apparatus; and the control module receives entry information through the communication module, receives, in response to the entry information, an elevator image acquired by the sensing apparatus, analyzes the elevator image to recognize internal space of the first elevator, and drives the moving apparatus according to the internal space.

8. The autonomous mobile robot fleet according to claim 2, wherein the robot fleet comprises at least one robot, and the dispatch information comprises the project data; the robot comprises a communication module, a control module, and a moving apparatus; the control module couples to the communication module and the moving apparatus; the control module and the communication module are located on the moving apparatus; and the control module is further configured to generate arrival data after the project data is completed, transmit the arrival data to the monitoring module through the communication module, and drive the moving apparatus to return to a start location.

9. The autonomous mobile robot fleet according to claim 8, wherein the certificate information comprises a completion certificate and an exception certificate; when the robot arrives at the start location, the control module is further configured to generate return data and transmit the return data to the certificate module through the communication module; and the certificate module confirms, when receiving the return data of any robot, whether there is the dispatch information and the arrival data of the robot, and generates the completion certificate in response to that there is the dispatch information and the arrival data of the same robot, or generates the exception certificate in response to that there is not the arrival data of the same robot.

10. The autonomous mobile robot fleet according to claim 1, wherein the robot fleet comprises at least one robot, and the dispatch information comprises first map information; the robot comprises a communication module, a control module, another storage module, and a moving apparatus; the control module couples to the communication module, the another storage module, and the moving apparatus; the control module, the communication module, and the another storage module are located on the moving apparatus; the another storage module stores second map information; and the control module is further configured to download the first map information through the communication module, and update the second map information with the first map information.

11. The autonomous mobile robot fleet according to claim 10, wherein the second map information comprises charging location data; the robot further comprises a power supply module; the power supply module couples to the control module and located on the moving apparatus; the power supply module stores remaining power, and provides, with the remaining power, power required by operation of the robot; and the control module drives the moving apparatus according to the charging location data in response to that the remaining power is less than or equal to a threshold.

12. The autonomous mobile robot fleet according to claim 1, wherein the dispatch information comprises cleaning and disinfection data; a robot in the robot fleet comprises a cleaning and disinfection apparatus, a communication module, a control module, and a moving apparatus; the control module couples to the communication module, the cleaning and disinfection apparatus, and the moving apparatus; the control module, the communication module, and the cleaning and disinfection apparatus are located on the moving apparatus; and the control module receives the dispatch information through the communication module, and controls the cleaning and disinfection apparatus according to the cleaning and disinfection data.

13. An autonomous mobile robot fleet control method, wherein at least one piece of monitoring information of at least one robot is stored, mission information is obtained, dispatch information is generated according to the mission information, and the dispatch information is transmitted to a selected robot in the at least one robot according to the monitoring information of each robot; and the autonomous mobile robot fleet control method comprises:
receiving, from the at least one robot, at least one status signal corresponding to the monitoring information of the robot;
updating, according to a status signal of each robot, the monitoring information of the robot; and
generating certificate information according to the dispatch information and the monitoring information.

14. The autonomous mobile robot fleet control method according to claim 13, further comprising:
receiving a call signal from the selected robot, the call signal comprising height data and plane data;
controlling an elevator corresponding to the plane data to move to a floor corresponding to the height data; and
sending an entry command to the selected robot after the elevator arrives at the floor.

15. The autonomous mobile robot fleet control method according to claim 14, further comprising:
acquiring an elevator image of the elevator in response to the entry command;
analyzing the elevator image to recognize internal space of the elevator; and
driving the selected robot according to the internal space.

16. The autonomous mobile robot fleet control method according to claim 13, wherein a transmission step comprises:
selecting one of the at least one robot as the selected robot according to idle data in the monitoring information and project data and location data in the dispatch information; and
transmitting the dispatch information to the selected robot.

17. The autonomous mobile robot fleet control method according to claim 13, wherein a transmission step comprises:
selecting one of the at least one robot as the selected robot according to idle data and power data in the monitoring information and project data and location data in the dispatch information; and
transmitting the dispatch information to the selected robot.

18. The autonomous mobile robot fleet control method according to claim 13, wherein a transmission step comprises:
selecting one of the at least one robot as the selected robot according to idle data, power data, and position data in the monitoring information and project data and location data in the dispatch information; and
transmitting the dispatch information to the selected robot.

19. The autonomous mobile robot fleet control method according to claim 13, further comprising: receiving return data from any robot, wherein
a generating step is performed in response to the return data, and the generating step comprises:
checking the dispatch information and the monitoring information in response to the return data; and
generating a completion certificate when there is the dispatch information of the robot sending the return data and the monitoring information comprises arrival data of the robot sending the return data; or
generating an exception certificate when there is the dispatch information of the robot sending the return data and the monitoring information does not comprise the arrival data.

20. The autonomous mobile robot fleet control method according to claim 19, further comprising:
executing, by the selected robot, the dispatch information;
sending back, by the selected robot, the arrival data when completing project data in the dispatch information, and returning to a start location;
sending back, by the selected robot, the return data when arriving at the start location; and
receiving and recording, in the certificate information, the arrival data from the selected robot.
